(19) United States
(12) Patent Application Publication
(10) Pub. No.: US 2011/0170646 A1
(43) Pub. Date: Jul. 14, 2011

(54) Nuclear Energy Converter

(76) Inventor: Alfons Roschel, Riegelsberg (DE)

(21) Appl. No.: 12/863,524

(22) PCT Filed: Jan. 24, 2009
(86) PCT No.: PCT/DE2009/000101

§ 371 Date: Oct. 6, 2010

(30) Foreign Application Priority Data
Feb. 2, 2008 (DE) 10 2008 007 309.1
Mar. 3, 2008 (DE) 10 2008 012 269.6
Jul. 12, 2008 (DE) 10 2008 032 675.5
Sep. 3, 2008 (DE) 10 2008 044 661.0

(51) Int. Cl. H05H 1/22

(52) U.S. Cl. 376/103

(57) ABSTRACT

One or more beam channels through which laser beams are directed, via one or more lasers, onto material of a sample in a sample chamber, are placed in a sample body. The laser beams generate a plasma in the material of the sample and directly or indirectly trigger reactions in the atomic nucleus or the electron shell. These reactions lead to a nuclear fission or fusion or to the generation of gamma rays or neutrons. Furthermore, gamma rays or neutrons can be conveyed to the sample body or to the beam channels, in order to trigger the same reactions. Discs can prevent or delay thermal energy or plasma from escaping in the beam channels. A positive or negative voltage U can be applied to the sample body or to electrodes situated within it, in order to suck up or convey electrons and favour the desired reactions. The sample body may be wholly or partially transparent, in order to adjust the focal points of the laser beams onto the material of the sample. The laser beams may be conveyed to the beam channels via optical wave guides.

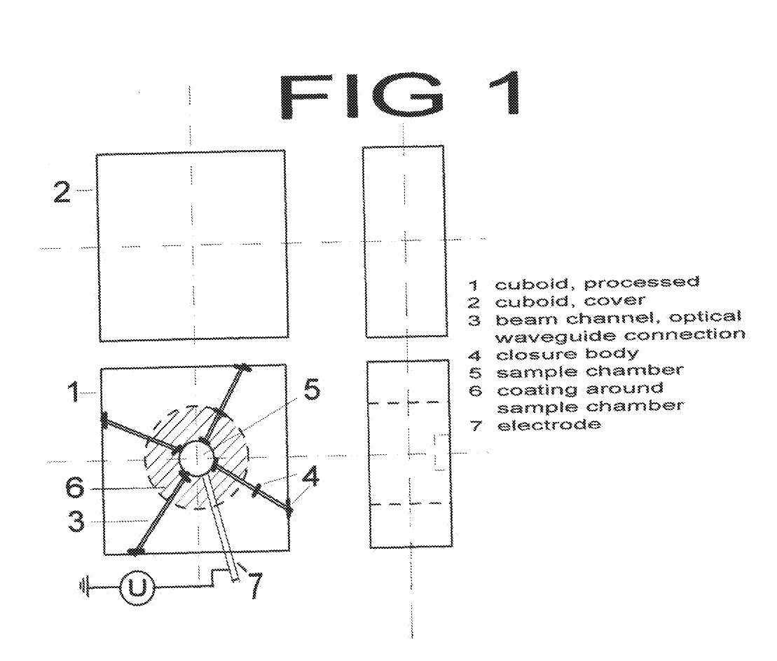

For fission or fusion of atomic nuclei by means of laser beams, high-power lasers are utilised, without a sufficient degree of efficiency for energy recovery being achieved. This is also due to the fact that the material to be split is suspended freely in the air. Should it be split directly by laser beams, or indirectly by means of gamma rays generated by laser beams, due to bremsstrahlung, or neutrons, a nuclear explosion of the small quantity of fissionable materials results in the case of which the energy emitted is less than that conveyed to the laser. Following the explosion in the air, no more energy is available for further nuclear reactions. Thus, the degree of efficiency remains low.

The problem underlying the invention specified in patent claim 1 is to achieve nuclear fission and/or nuclear fusion with sufficient energy recovery by means of laser beams, gamma rays or neutrons directly—or indirectly if gamma rays or neutrons are only released through laser beams. This is achieved by the material to be split or fused, from now on referred to as material of the sample, being placed in a sample chamber of a sample body.

The sample body may be constructed in any geometric form. In the sample body, one or more beam channels lead to the sample chamber, in which material of the sample which is supposed to be irradiated by laser beams, gamma rays or neutrons is placed.

One or more laser beams are directed onto the material of the sample via one or more beam channels, wherein their focal points are directed onto the material of the sample. By this means, the laser energy conveyed and, in addition, the energy being released from reactions of the components of the atomic nucleus, is stored within the sample body. As a result, nuclear fission and nuclear fusion can be achieved for a larger quantity of material than with the laser irradiation of a sample suspended in the air alone. In that way the energy efficiency is increased.

Gamma rays or neutrons can also be directed through the sample body or the beam channel(s) onto the material of the sample, in order to trigger reactions in the atomic nucleus or the electron shell.

By irradiating the material of the sample with lasers, gamma rays can also arise from bremsstrahlung, and neutrons can be released. Both processes can likewise trigger nuclear fission. As is generally known, with appropriate arrangement of material to be split and fused, nuclear fusion can also be triggered by nuclear fission. This can also be achieved in these sample bodies. It is also to be expected that, when putting this novel invention to the test, atomic physics reactions which have up to now not yet been known will occur.

Through a coating, in particular in the region of the sample chamber, with material which deflects the gamma rays, and/or material which deflects or decelerates neutrons, gamma rays and neutrons can again be conducted back to the sample. As a result, a nuclear fission and, with an appropriate arrangement, a nuclear fusion can be achieved in more material of the sample, by means of which the energy efficiency is increased.

The coating in the region of the sample chamber with materials which deflect gamma rays, as well as deflect or decelerate neutrons, can be carried out with the materials and in accordance with the methods which are already used for this according to the state of the art in tests in nuclear physics or for the construction and ongoing development of nuclear weapons. The materials for this coating can be introduced in very small particles, right up to nanostructures, in order to improve the deflection of gamma rays and neutrons, as well as improve the deceleration of the latter.

The laser beam generates a plasma in the material of the sample. By applying a voltage U, which can be adjusted between a positive maximum value +Umax and a negative maximum value −Umax, electrons can be sucked up or conveyed to the electrically conductive plasma of the material in the sample chamber. Should electrons be sucked up by applying a positive voltage, the atom is weakened, which can have an advantageous effect upon the nuclear fission or nuclear fusion. When creating a negative voltage, electrons are conveyed to the plasma, which may lead to more gamma radiation through bremsstrahlung, which can likewise have an advantageous effect on the nuclear fission and nuclear fusion.

The sample body itself may be electrically conductive, so that the voltage applied to it also abuts the conductive plasma of the sample chamber. Should the sample body or the coating in the region of the sample chamber not be electrically conductive, or not sufficiently so, electrodes may be affixed in the sample body, which reach into the sample chamber and connect the plasma of the material of the sample with the voltage supply source U. It is also possible to refrain from applying a voltage and only irradiate the sample by means of laser, gamma rays or neutrons.

By applying several beam channels, which are directed onto the sample in the sample body, several lasers can irradiate the sample simultaneously. Furthermore, several types of lasers with persistent radiation or beam momentum may be utilised together, by means of which more laser energy can be conveyed to the material of the sample. In this way, an energy density of the laser radiation previously not attained is achieved. Multiple rays from lasers can also be conveyed via a beam channel. In addition, there is also the possibility of utilising gamma rays and neutrons as well.

The beam channels may be sealed by means of one or more discs which are permeable to laser beams. It is thereby prevented, or at least temporarily hindered, that energy or plasma leaks from the sample chamber through the beam channels. In that way, more laser energy can be conveyed to the material of the sample.

The sample body may also be transparent or partially transparent, so that the focal point of the laser beam can be directed onto the material of the sample.

The laser beams can be conveyed directly through the beam channels or via optical wave guides attached to the beam channels to the sample body.

The sample body may also be used to generate gamma rays or neutrons by means of laser beams from the material of the sample. Very many practical applications arise for such a source of gamma rays and neutrons.

The benefits achieved with the invention principally consist in that, through the storage of the laser energy of the incoming laser radiation, the sucking up or conveyance of electrons by applying a positive or negative voltage U, the utilisation of several, also different, types of lasers over one or more beam channels, with or without a disc, and the coating in the region of the sample chamber through introducing materials which deflect gamma rays and deflect or decelerates neutrons, the energy efficiency of the nuclear fission and fusion is increased by laser beams. Thus, more nuclear energy is released than energy has to be conveyed to the laser. This useful energy may then be used industrially in accordance with the state of the art. For this purpose, nuclear fission and/or fusion is triggered continuously, also in sample bodies which are conveyed in succession. The reactions described above can also be triggered in the atom through gamma rays or neutrons conveyed from outside.

An advantageous embodiment of the invention is specified in patent claim 1. The beam channel in which the laser beam(s) enter(s) runs within the sample body to the material of the sample in the sample chamber. Several beam channels are led from various directions to the material of the sample in the sample chamber.

A further advantageous embodiment of the invention is given in patent claim 2. In this respect, the sample body consists, or partially consists, of transparent material, in order to be able to monitor the position of the focal point of the laser beams in the material of the sample.

A further advantageous embodiment of the invention is given in patent claim 3. In this respect, discs made of material which lets laser beams through are placed at the beginning or the end of or in the course of the beam channels. In the case of irradiation with gamma rays or neutrons, the material of the discs is permeable to the latter.

A further advantageous embodiment of the invention is given in patent claim 4. In this respect, materials which reflect gamma rays or reflect or decelerate neutrons are introduced around the sample chamber. In that way the number of nuclear fissions can be increased.

A further advantageous embodiment of the invention is given in patent claim 5. In this respect, a voltage U, which can be adjusted between +Umax and −Umax, is applied to the electrically insulated positioned sample body, which is itself electrically conductive. Via the conductive sample body, this voltage supply source is linked to the plasma of the material of the sample in the sample chamber.

A further advantageous embodiment of the invention is given in patent claim 6. In the case of non-conductive material of the sample body, the voltage U is conveyed by means of electrodes in the sample body to the plasma of the material of the sample body. Using this voltage, electrons are sucked up or conveyed from the plasma.

A further advantageous embodiment of the invention is given in patent claim 7. In this respect, the laser beam(s) is/are conveyed to the beam channels of the sample body by means of optical wave guides. The optical wave guides can be adjusted in their length in such a way that the focal points of the laser beams lie in the material of the sample.

A further advantageous embodiment of the invention is given in patent claim 8. In this respect, gamma rays or neutrons are directed onto the sample body or the beam channels, in order to thereby irradiate the material of the sample. Discs in the beam channels are, in that respect, constructed so as to be permeable to gamma rays and neutrons.

An embodiment of the invention is shown in the drawing 1/1. The sample body is divided into two cuboids 1 and 2. In the first cuboid, the beam channels 3 are arranged on a plane and equipped with discs 4. The latter are charted in the drawing, for example at the beginning, at the end of or in the course of the beam channels. In the centre of the sample body the cylindrical sample chamber 5 for the material of the sample is to be found. Materials 6, which deflect gamma rays and/or deflect or decelerate neutrons, are introduced around the sample chamber 5. The voltage U is applied by means of electrodes 7 to the plasma of the material of the sample. The second cuboid is attached to the first, for example by being screwed to it.

1. A nuclear energy converter for generating nuclear reactions through laser beams, comprising: in a sample body with one or more beam channels in a sample chamber materials are heated by means of laser beams to the plasma state, wherein the energy of the laser beams and the nuclear reactions is stored in the plasma.

2. A nuclear energy converter in accordance with claim 1, comprising a voltage between +Umax and −Umax is applied to the plasma of the sample chamber via an electrically conductived sample body or via electrodes, in order to suck up or convey electrons out of the plasma via the electromotive force of the voltage supply source.

3. A nuclear energy converter in accordance with claim 1, comprising layers of substances in which materials which deflect neutrons or radioactive rays are embedded in the nanostructure are contained in the sample body.

4. A nuclear energy converter in accordance with claim 1, comprising materials which reflect gamma rays or reflect or decelerate neutrons are placed in the region of the sample chamber.

5. A nuclear energy converter in accordance with claim 1, comprising a voltage between +Umax and −Umax can be applied to an electrically conductive sample body, in order to suck or convey electrons out of the plasma of the material of the sample.

6. A nuclear energy converter in accordance with claim 1, comprising electrodes which reach to the plasma of the material of the sample are attached to an electrically non-conductive sample body; a voltage between +Umax and −Umax can be applied to the electrodes, in order to suck up or convey electrons out of the material of the plasma of the sample.

7. A nuclear energy converter in accordance with claim 1, comprising the laser beams are conveyed to the beam channels via optical wave guides, the length of which can be determined in such a way that the focal point of the laser beams lies in the material of the sample.

8. A nuclear energy converter in accordance with claim 2, comprising gamma rays or neutrons are directed from outside onto the sample body or into the beam channels, in order to bring about reactions in the atomic nucleus or the electron shell in the material of the sample, whereby any discs in the beam channels are permeable to gamma rays or electrons.

9. A nuclear energy converter in accordance with claim 3, comprising gamma rays or neutrons are directed from outside onto the sample body or into the beam channels, in order to bring about reactions in the atomic nucleus or the electron shell in the material of the sample, whereby any discs in the beam channels are permeable to gamma rays or electrons.

10. A nuclear energy converter in accordance with claim 4, comprising gamma rays or neutrons are directed from outside onto the sample body or into the beam channels, in order to bring about reactions in the atomic nucleus or the electron shell in the material of the sample, whereby any discs in the beam channels are permeable to gamma rays or electrons.

11. A nuclear energy converter in accordance with claim 5, comprising gamma rays or neutrons are directed from outside onto the sample body or into the beam channels, in order to bring about reactions in the atomic nucleus or the electron shell in the material of the sample, whereby any discs in the beam channels are permeable to gamma rays or electrons.

12. A nuclear energy converter in accordance with claim 6, comprising gamma rays or neutrons are directed from outside onto the sample body or into the beam channels, in order to bring about reactions in the atomic nucleus or the electron shell in the material of the sample, whereby any discs in the beam channels are permeable to gamma rays or electrons.
